(19) United States
(12) Patent Application Publication
(10) Pub. No.: US 2025/0128204 A1
(43) Pub. Date: Apr. 24, 2025

(54) REDUCED REAGENT REGENERATION ENERGY FOR CARBON DIOXIDE CAPTURE WITH BIPOLAR MEMBRANE ELECTRODIALYSIS, SYSTEMS AND RELATED METHODS

(71) Applicant: Michigan Technological University, Houghton, MI (US)

(72) Inventors: Surendra Komar KAWATRA, Fort Meyers, FL (US); Sriram VALLURI, Grayslake, IL (US)

(21) Appl. No.: 18/834,330

(22) PCT Filed: Jan. 30, 2023
(86) PCT No.: PCT/US2023/011818

§ 371 Date: Jul. 30, 2024

Related U.S. Application Data
(60) Provisional application No. 63/267,320, filed on Jan. 31, 2022.

(51) Int. Cl. B01D 53/62; B01D 53/78; B01D 53/96

(52) U.S. Cl. CPC B01D 53/62; B01D 53/78; B01D 53/965; B01D 2251/304; B01D 2251/506; B01D 2251/604; B01D 2257/504; B01D 2258/0283

(57) ABSTRACT

A system and process for the capture of carbon dioxide from a gaseous feedstock, regenerating carbon dioxide in a purified form, and regenerating reagents, wherein the reagent regeneration having reduced energy consumption in relation to carbon dioxide capture. Carbon dioxide captured by a slurry scrubbing solution producing a resultant product that can be reacted with an acid reagent to form the regenerated carbon dioxide and a resultant salt solution. Electrodialysis with bipolar membrane separation employed on the resultant salt solution to form regenerated acid and regenerated base. The regenerated base recirculated as the scrubbing solution to capture additional carbon dioxide, and the regenerated acid recirculated for additional acid reaction with additional resultant product, such that the system and process can continuously capture and form regenerated carbon dioxide in a purified form compared to the carbon dioxide of the gaseous feedstock.

### CLAIM FOR PRIORITY

This application is a National Phase entry of PCT International Application PCT/US2023/011818 filed Jan. 30, 2023 which claims the benefit of priority of U.S. Provisional Patent Application No. 63/267,320 filed Jan. 31, 2022, the subject matter of which is incorporated by reference in its entirety.

### TECHNICAL FIELD

The present invention relates generally to carbon dioxide capture and the regeneration of reagents relating to the carbon dioxide capture, particularly chemical regeneration of an alkali absorbent solution and carbon dioxide by the chemical reaction of sodium bicarbonate with an acid and the resultant solution subjected to electrodialysis with bipolar membrane separation for regenerating the alkali absorbent solution and the acid reagent.

### BACKGROUND

Flue gas emissions—the emitted material produced when fossil fuels such as coal, oil, natural gas, or wood are burned for heat or power—may contain pollutants, including carbon dioxide (CO₂), nitrogen oxides (NOx) and sulfur oxides (SOₓ). Capturing flue gases from power plants is typically a multi-step process.

With current environmental regulations, CO₂ capture is very crucial for the survival of coal-fired power plants in the near future. Efforts to capture CO₂ at some power plants have been successful, but the cost of installing and operating the required equipment is high. As such, very few power plants have carbon capture and storage (CSS) systems. In order for the sale of captured CO₂ to become a profitable venture, the cost of capturing the CO₂ from a flue gas must be reduced.

Several post-combustion CO₂ capture technologies exist, such as chemical absorption, physical adsorption and membrane separation. Among all of the CO₂ capture technologies, post combustion chemical absorption CO₂ capture is the most mature, competitive and economically viable for CO₂ capture from fossil fuel fired power plants. The only draw back associated with post combustion capture is the high energy requirement for CO₂ capture reagent regeneration.

Reagent regeneration energy accounts for approximately 70% of the CO₂ capture costs. It has previously been reported that thermal regeneration energy with amine solvents is in the range of 3-4 MJ/Kg of CO₂ captured. This makes thermal regeneration highly energy intensive, increasing the overall CO₂ capture costs to around 55-60 $/ton of CO₂ captured. In order to reduce this cost and make CO₂ capture affordable, alternate reagent regeneration routes have to be explored.

Previously, CO₂ capture with NaOH and direct electrodialysis of resulting NaHCO₃ solution for regenerating NaOH and CO₂ in the electrolysis with dipolar membrane (EDBM) cell has been examined, which has a lot of process inefficiencies such as low current efficiency, low CO₂ recovery (40-60%) and high cell resistance, etc, as discussed below. Amines, ammonia and alkaline solutions have been thoroughly studied by several researchers as absorbents to capture CO₂ from post-combustion flue gases. Extensive research has been performed on the aspects of absorption process, reagent efficiency, mass transfer coefficient, etc. The chemical reactions for CO₂ capture with alkali absorbent solutions of sodium hydroxide (NaOH) and sodium carbonate (Na₂CO₃) are shown in Equations (1)-(3):

CO₂(aq)+H₂O(l)→H₂CO₃(aq) (1)

H₂CO₃ (aq)+Na₂CO₃ (aq)→NaHCO₃(aq) (2)

NaOH(aq)+H₂CO₃(aq)↔NaHCO₃(aq)+H₂O(l) (3)

When CO₂ is dissolved in water it forms carbonic acid (H₂CO₃) as shown in Equation (1), which reacts with an alkali absorbent, such as sodium carbonate (Na₂CO₃) in Equation (2) and sodium hydroxide (NaOH) in Equation (3), to form sodium bicarbonate (NaHCO₃). While Na₂CO; solution and NaOH solution have varying chemical absorption for CO₂ capture from flue gas, one of the major problems facing post-combustion CO₂ capture is the high energy requirement for reagent regeneration.

Reagent regeneration is the most energy intensive step in post combustion CO₂ capture process. One approach to reagent regeneration is thermal regeneration as shown in FIG. 1, which comprises heating the resultant capture solution, such as sodium bicarbonate, to decompose the resultant capture solution to release CO₂ and regenerate the starting absorbent, such as sodium carbonate, which can then be recycled and reused for CO₂ capture from a flue gas. However, thermal regeneration can cost a massive amount of energy, which can be greater than 3.0 MJ/kg of CO₂ captured.

A different approach to thermal regeneration involves capturing CO₂ with an alkali absorbent solution and then directly regenerating the CO₂ by electrodialysis of the resultant NaHCO₃ solution. Not only has the study of this process been limited, but there are many draw backs associated with direct electrodialysis of a NaHCO₃ solution. One draw back is part of the energy for catalyzing the reaction between the H⁺ and HCO₃⁻ ions for producing CO₂. Another draw back is that the presence of CO₂ gas bubbles in the electrodialysis cell increases electrical resistance across the cell, reducing electrical conductivity and resulting in low current efficiency and high energy consumption. Also, it has been reported that the CO₂ recoveries are only 40-60% with the lowest energy being 2.1 MJ/Kg CO₂. A further observed electrodialysis drawback of CO₂ loaded monoethanolamine (MEA) solution is membrane degradation due to heat stable salt anions. Still further, during direct electrodialysis, as the current density of the EDBM cell increases, the CO₂ recovery often increases, but the tremendous increase in energy consumption does not make the high CO₂ recovery a very good trade off at higher current densities. Still further, due to the presence of gas bubbles in the EDBM cell, elevated pressures as high as 10 atm have to be applied to keep the CO₂ in the solution phase until the pressure is released downstream, which drastically increases pumping and other variable costs.

Accordingly, there is a need in the industry to decrease reagent cost for post-combustion CO₂ capture. There is also a need in the industry to provide reagents for CO₂ capture that have an acceptable absorption rate and low energy regeneration of the reagents, such that the reagents can be recycled and reused for additional acceptable absorption of CO₂ capture. There is still further a need in the industry to provide acceptable CO₂ capture with reagents that do not result in undesirable oxidative degradation and corrosion of equipment or that are harmful to the environmental.

### SUMMARY

The system and processes of the present invention meet the needs of the industry by providing reagents for CO₂ capture that have an acceptable absorption rate, low energy regeneration of the reagents, such that the reagents can be recycled and reused for additional acceptable absorption of CO₂ capture, reagents that do not result in undesirable oxidative degradation and corrosion of equipment, and a technology that is economically feasible while also being environmentally benign.

In some aspects, the system and process of the present disclosure is directed to carbon dioxide capture with reagent regeneration having reduced energy consumption, particularly carbon dioxide captured from a flue gas employing a scrubber solution in a scrubber column.

In some aspects, the system of the present invention comprises a scrubber column having a scrubber solution configured to capture carbon dioxide in the scrubber column by a gaseous feedstock reacting with the scrubber solution to form a sodium bicarbonate solution, the system further comprising a reaction tank whereby carbon dioxide is capable of being regenerated from the sodium bicarbonate solution by reaction with an acid providing regenerated carbon dioxide in a clean form and a resultant salt solution, the system further comprising an electrodialysis regeneration unit having a bipolar separation membrane whereby the resultant salt solution can be subjected to electrodialysis with bipolar membrane separation for separation of the resultant salt solution into an acid and base. In some preferred aspects, the regenerated base can be circulated back to the scrubber column to capture additional carbon dioxide as a scrubbing solution. In some preferred aspects, the regenerated acid can be circulated back to an acid reaction tank for additional acid reaction with sodium bicarbonate for carbon dioxide regeneration. In some preferred aspects the system provides a continual loop of carbon dioxide capture from the gaseous feedstock and reagent regeneration.

In some aspects, the process of the present invention comprises feeding a gaseous stream into a scrubber column having a scrubber solution, the scrubber solution configured to capture carbon dioxide in the scrubber column from the gaseous feedstock by reacting the carbon dioxide in the gaseous stream with the scrubber solution to form a sodium bicarbonate solution. The process further comprising feeding the sodium carbonate solution from the scrubber column to an acid reaction tank, and reacting the sodium carbonate solution with an acid in the acid tank to regenerate carbon dioxide from the sodium bicarbonate solution and also form a resultant salt solution, the carbon dioxide preferably being provided in a clean form. The process further comprising feeding the resultant salt solution to an electrodialysis regeneration unit having a bipolar separation membrane for regeneration of the slurry solution and the acid, and subjecting the resultant salt solution to electrodialysis with bipolar membrane separation for separating the resultant salt solution into the regenerated acid and 30) base. In some preferred aspects, the regenerated base is the slurry solution, which can be circulated back to the scrubber column to capture additional carbon dioxide as a scrubbing solution. In some preferred aspects, the regenerated acid can be circulated back to an acid reaction tank for additional acid reaction with sodium bicarbonate for carbon dioxide regeneration. In some preferred aspects the processes is continual, such that carbon dioxide is continually captured from the gaseous feedstock by the slurry solution in the slurry column, and the reagents employed for carbon dioxide capture and regeneration are also capable of being regenerated.

In some preferred aspects of the system and process, the scrubbing solution for capturing CO₂ in the scrubbing column is an alkali absorbent solution. In some aspects, the scrubbing solution is an alkali metal hydroxide solution. In some preferred aspects, the scrubbing solution is sodium hydroxide (NaOH), potassium hydroxide (KOH), or a combination thereof. In some preferred aspects, the scrubbing solution comprises sodium hydroxide.

In some preferred aspects of the system and process, the acid for regenerating CO₂ from the NaHCO₃ solution is an organic, a mineral acid, or a combination thereof. In some preferred aspects, the acid comprising a mineral acid. In some more preferred aspects, the acid comprises sulfuric acid (H₂SO₄), such that the acid regeneration to form CO₂ provide the resultant salt solution comprising a sodium sulfate (Na₂SO₄) solution.

In some preferred aspects of the system and process, electrodialysis with bipolar membrane separation (EDBM) is employed on the resultant salt solution to separate an alkali metal hydroxide solution from a mineral acid, more preferably to separate sodium hydroxide, potassium hydroxide, or a combination thereof from sulfuric acid, and even more preferably to separate sodium hydroxide from sulfuric acid. In some preferred aspects, the regenerated base, preferably an alkali metal hydroxide solution, more preferably sodium hydroxide, potassium hydroxide, or a combination, and even more preferably sodium hydroxide, is circulated back to the scrubber column as a scrubber solution for additional capture of carbon dioxide from the gaseous stream. In some preferred aspects, the regenerated acid, preferably an organic acid, a mineral acid, or a combination thereof, preferably a mineral acid, more preferably sulfuric acid, is circulated back to the acid reaction tank as an acid additional reaction with sodium bicarbonate to regenerate carbon dioxide and a salt solution.

In some aspects, the EDBM unit comprises one or more EDBM cells. In some aspects, the EDBM unit comprises two or more EDBM cells. In some other aspects, the EDBM unit comprises a plurality of EDBM cells. In some aspects, a EDBM unit may comprise between 1 and about 10,000 EDBM cells, in some aspects between about 10 and about 5,000 EDBM cells, in some aspects between about 50 and about 4,000 EDBM cells, in some aspects between about 100 and about 3,500 EDBM cells, in some aspects between about 250 and about 3,250 EDBM cells, and in some other aspects between about 500 and about 3,000 EDBM cells.

In some aspects, each EDBM cell includes at least one cation exchange membrane and at least one bipolar membrane, each of the cation exchange and bipolar membranes proximately located between an anode and a cathode. In some aspects, each EDBM cell includes at least one cation exchange membrane and at least two bipolar membranes, wherein the cation exchange membrane proximately located between two of the at least two bipolar membranes, such that the membranes are proximately located between an anode and a cathode. In some aspects, each EDBM cell includes a series of membrane assemblies, each membrane assembly having at least one cation exchange membrane and at least two bipolar membranes, wherein each cation exchange membrane proximately located between two adjacent bipolar membranes, such that the membranes are proximately located between an anode and a cathode.

In some aspects, each EDBM cell has at least one acid compartment and at least one base compartment. In some aspects, the base compartment is the space between a cation exchange membrane and an adjacent bipolar membrane that is proximately located on the cathode side of the cation exchange membrane. In some aspects, the acid compartment is the space between the cation exchange membrane and an adjacent bipolar membrane proximately that is located on the anode side of the cation exchange membrane.

In some aspects, the scrubbing column is a counter current absorption column.

In some aspects, the regenerated sodium hydroxide solution fed to the scrubbing column, reaction of the CO₂ of the gaseous mixture fed into the scrubber column with the regenerated sodium hydroxide solution to provide a sodium bicarbonate solution, the sodium bicarbonate solution being subjected to an acid for carbon dioxide regeneration and to provide a salt solution, and the regeneration and separation of the acid and base from the salt solution, is continuous comprising one or more regeneration cycles.

In some aspects, CO₂ regeneration of at least 90% is achieved, in some aspects at least 95%, in some aspects at least 98%, in some aspects at least 99%, in some aspects at least 99.5%, in some aspects at least 99.9%, and in some aspects essentially 100%.

In some aspects of the system and process, a concentration of sodium hydroxide in the scrubbing solution is between about 0.1 and about 0.4 mol/L, more preferably between about 0.225 and about 0). 375 mol/L, more preferably between about 0.25 and about 0.35 mol/L.

In some aspects, the EDBM unit comprises a two-compartment configuration or a three-compartment configuration, preferably a two-compartment configuration.

In some aspects, a current density of the EDBM unit is over 100 A/m², in some aspects over about 100 A/m², in some aspects over about 110 A/m², in some aspects over about 120 A/m², in some aspects over about 130 A/m², and in some preferred aspects over about 140 A/m². In some aspects, the current density of the EDBM unit is less than about 200 A/m², in some aspects less than about 195 A/m², in some aspects less than about 190 A/m², in some aspects less than about 185 A/m², and in some preferred aspects less than about 180 A/m². In some aspects, the current density of the EDBM unit is over 100 A/m² and less than about 200 A/m², in some aspects over about 110 A/m² and less than about 190 A/m², in some aspects over about 120 A/m² and less than about 195 A/m², in some aspects over about 130 A/m² and less than about 185 A/m², and in some preferred aspects over about 140 A/m² and less than about 180 A/m².

In some aspects, a current efficiency of the EDBM unit is at least 80%, in some aspects at least about 85%, in some aspects at least about 90%, and in some other aspects at least about 95%.

In some aspects of the system and process, a concentration of sodium hydroxide regenerated by the EDBM unit is between about 0.1 and about 0.4 mol/L, more preferably between about 0.225 and about 0.375 mol/L, more preferably between about 0.25 and about 0.35 mol/L.

In some aspects, a regeneration energy for the system and process of the present invention is less than about 3.0 MJ/KgCO₂, preferably less than about 2.5 MJ/KgCO₂, preferably less than about 2.0 MJ/KgCO₂, preferably less than about 1.5 MJ/KgCO₂, preferably less than about 1.4 MJ/KgCO₂, preferably less than about 1.3 MJ/KgCO₂, preferably less than about 1.2 MJ/KgCO₂, preferably less than about 1.1 MJ/KgCO₂, and preferably less than about 1.0 MJ/KgCO₂.

In some aspects, the system and process are capable of regeneration of carbon dioxide, acid and/or base at room temperature.

In some aspects, the system and process are capable of regeneration of carbon dioxide, acid and/or base at atmospheric pressure conditions.

In some aspects, the system and process are capable of regeneration of carbon dioxide, acid and/or base at room temperature and atmospheric pressure conditions.

In some aspects, the system and process further comprise a filtration assembly prior to the scrubber column, wherein the filtration assembly filters particulates from the gaseous feedstock.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a process flow diagram of a system and process for continuous CO₂ capture and thermal regeneration of a scrubbing solution, wherein flue gas (CO₂ mixed with air) is fed into the scrubbing column from the bottom and the scrubbing solution is fed into the scrubbing column from the top for a counter-current direction than for CO₂ absorption by the scrubbing solution: after CO₂ is absorbed by the scrubbing solution, the resultant reactant solution (in some aspects preferably a sodium bicarbonate solution) exits the scrubbing column and is fed to a thermal regeneration system and process whereby the CO₂ and scrubbing solution are regenerated, with the scrubbing solution fed back to the scrubbing column for further CO₂ absorption from the flue gas.

FIG. 2 is a process flow diagram of a system and process for continuous CO₂ capture and regeneration of reagents and CO₂ in a purified form, wherein a gaseous feedstock, preferably a flue gas, is introduced into a CO₂ capture assembly, preferably a scrubbing assembly having a scrubbing column and a slurry scrubbing solution preferably comprising sodium hydroxide, sodium carbonate, or a mixture thereof, to produce a resultant product, preferably a sodium bicarbonate that exits the CO₂ capture assembly. Resultant product can be introduced into a regeneration assembly preferably comprising a reaction tank wherein the resultant product is reacted with an acid reagent, preferably the acid reagent comprising sulfuric acid, to regenerate CO₂ in a purified form and a resultant salt solution, the resultant salt solution preferably comprising a sodium carbonate solution. The resultant salt solution can be subjected to an EDPM assembly, wherein the resultant salt solution is subjected to electrodialysis with one or more CEM and BPM to separate acid and base as regenerated acid and regenerated base, respectively. Regenerated base can be circulated back to the scrubber as the scrubbing solution to capture additional CO₂, regenerated slurry scrubbing solution preferably comprising sodium hydroxide, sodium carbonate, or a mixture thereof. Regenerated acid can be circulated back to the regeneration assembly, preferably a reaction tank, for additional reaction with resultant product for CO₂ regeneration and resultant salt solution formation. The foregoing system and process capable of being a continuous process for continual capture of CO₂ from the gaseous feedstock to produce regenerated CO₂ in a purified form, according to certain embodiments of the present invention.

FIG. 3 is a process flow diagram of the system and process of FIG. 2 used in the Experiment section, wherein the CO₂ capture assembly comprises a scrubbing assembly having a scrubbing column and a slurry scrubbing solution comprising NaOH, and wherein the regeneration assembly comprises an acid/base reaction tank whereby the resultant product comprising sodium bicarbonate from the scrubbing assembly is reacted with an acid comprising sulfuric acid to regenerate CO₂ in a purified form and provide a resultant salt solution comprising sodium carbonate that is subjected to the EDPM assembly, wherein the resultant salt solution is subjected to electrodialysis with one or more CEM and BPM to separate acid comprising sulfuric acid and base comprising NaOH as regenerated acid and regenerated base, respectively. Regenerated base can be circulated back to the scrubber as at least a portion of the scrubbing solution to capture additional CO₂. Regenerated acid can be circulated back to the regeneration assembly as a portion of the reactive acid for additional reaction with resultant product for CO₂ regeneration and resultant salt solution formation. The foregoing system and process capable of being a continuous process for continual capture of CO₂ from the gaseous feedstock to produce regenerated CO₂ in a purified form, according to certain embodiments of the present invention.

FIGS. 4A-4B are schematics of the two-compartment configuration of electrodialysis with bipolar membrane (EDPM) separation in FIGS. 2 and 3, each compartment of the two-compartment having a bipolar membrane (BPM) and a cation exchange membrane (CEM) as the repeating unit as shown by the dotted box in FIG. 3A, and the CEM and BPM membranes of FIG. 3A shown in more detail in FIG. 3B, according to certain embodiments of the present invention.

FIG. 5 is a graph illustrating CO₂ capture efficiency of NaOH at various concentrations at 38° C., wherein the error bars represent standard error (n=3).

FIG. 6A is a graph illustrating change in acid and base concentration with time at temperature T=30° C. voltage V=18 V in the EDPM system and process, according to certain embodiments of the present invention.

FIG. 6B is a graph illustrating current density versus time until the current reached a maximum value in the EDPM system and process, wherein the error bars represent standard error from three independent measurements, according to certain embodiments of the present invention.

FIG. 7A is a graph illustrating the effect of current density on energy consumption (vertical axis on the left side) per Kg of CO₂ captured and current efficiency (vertical axis on the right side) for the EDPM system and process, according to certain embodiments of the present invention.

FIG. 7B is a graph illustrating the effect of current density on NaOH concentration and CO₂ capture efficiency for the EDPM system and process, with the error bars representing the standard error of three independent measurements, according to certain embodiments of the present invention.

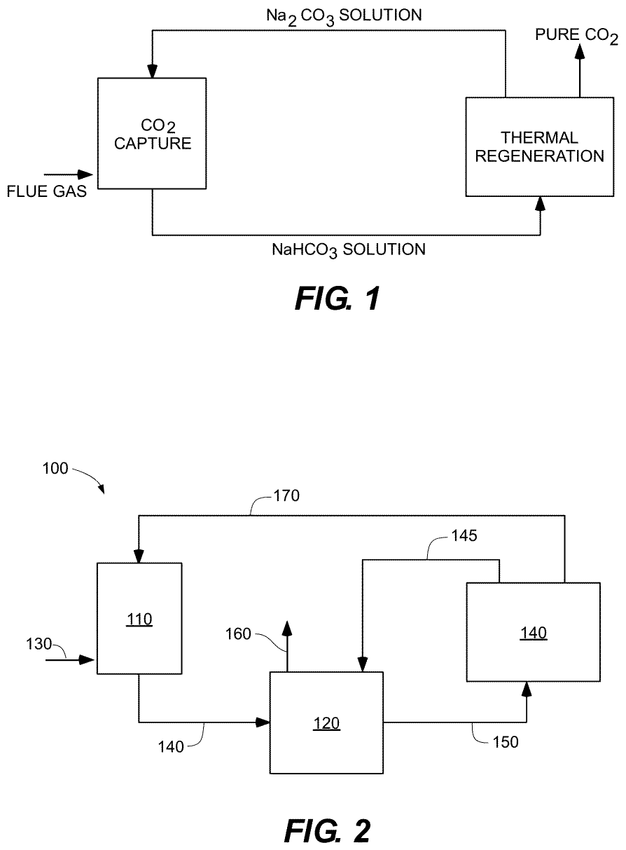

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Post combustion CO₂ capture with reagents such as amines, sodium carbonate and sodium hydroxide is the most mature CO₂ capture technology. One of the major challenges facing post combustion CO₂ capture is the high energy requirement for reagent regeneration. Thermal regeneration energy is currently in the range of 3-4 MJ/Kg CO₂ captured.

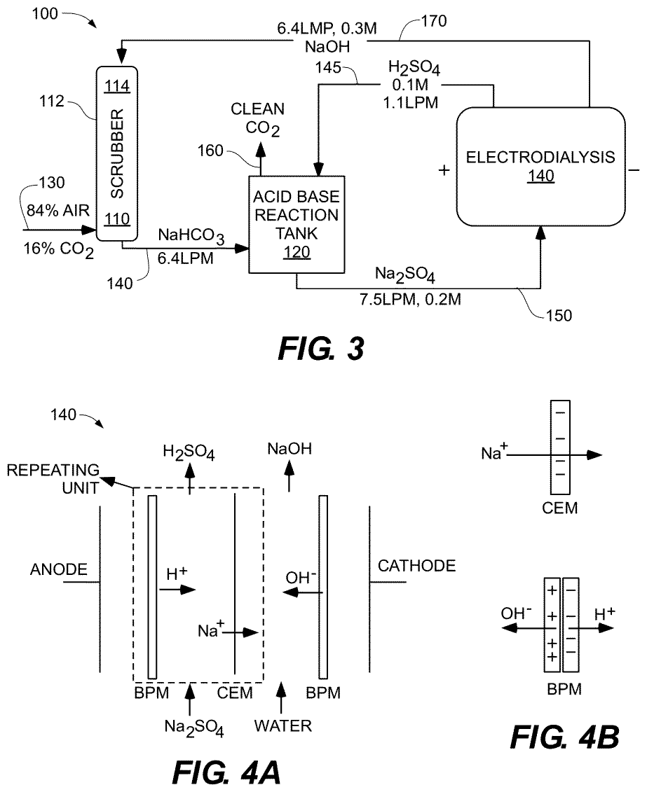

The present inventors were able to significantly reduce reagent regeneration energy by employing electrodialysis with bipolar membrane separation (EDBM), as shown in FIGS. 2 and 3, according to certain embodiments of the present invention.

As shown by the process flow diagram in FIG. 2, CO₂ capture and regeneration system 100 generally comprises CO₂ capture assembly 110 in fluid communication with each of regeneration assembly 120 and EDPM assembly 140, and regeneration assembly 120 being in fluid communication with EDPM assembly 140.

Capture assembly 110 can comprise any apparatus or system for capturing CO₂ from a feedstock. In some preferred aspects as shown by the process flow diagram in FIG. 3, capture assembly 110 comprises a scrubber assembly 110 preferably comprising scrubbing column 112, which contains slurry scrubbing solution 114, and a gaseous feedstock 130 is fed into scrubbing column 112. Slurry scrubbing solution 114 is preferably fed into scrubbing column 112 proximate a slurry solution inlet, which is preferably proximately located a top portion scrubbing column 112. Slurry scrubbing solution 114 can comprise fresh slurry scrubbing solution, regenerated slurry scrubbing solution, or a mixture thereof. Gaseous feedstock 130 preferably comprises a mixture of CO₂ and air, which is preferably fed into scrubbing column 112 proximate a gas inlet, which is preferably proximately located a bottom portion of scrubbing column. Scrubbing column 112 is preferably a packed-bed counter-current absorption column, such that the flow of slurry scrubbing solution 114 is in an opposite direction to the flow of gaseous feedstock 130.

Slurry scrubbing solution 114 and gaseous feedstock 130 are each preferably fed into scrubbing column 112, such that scrubber assembly 110 is capable of providing continuous CO₂ capture. During normal operation, CO₂ is absorbed from gaseous feedstock 130 by slurry scrubbing solution 114 providing resultant product 140, which is preferably a resultant product solution, configured to exit scrubbing column 112 proximate at a resultant product outlet 142, preferably proximately located bottom portion 134 of scrubbing column 112, providing resultant product stream 144. Gaseous feedstock 130 preferably being a flue gas or other carbon dioxide containing gaseous feedstock. A stream of resultant product 140 from scrubbing column 112 can be introduced into regeneration assembly 120. In some preferred aspects, resultant product 140) comprises a sodium bicarbonate solution. In some preferred aspects, a stream of resultant product 140 is continuously introduced into regeneration assembly 120.

Regeneration assembly 120 preferably comprises a reaction tank. Resultant product 140 introduced into regeneration assembly 140 can be reacted with an acid reagent 145 to regenerate CO₂ 160 in a purified form and a resultant salt solution 150. In some preferred aspects, acid reagent 145 comprises sulfuric acid. In some preferred aspects, resultant salt solution 150 preferably comprises a sodium carbonate solution.

Resultant salt solution 150 can be fed to EDPM assembly 140, wherein resultant salt solution 150 can be subjected to electrodialysis with one or more CEM and BPM to separate acid and base as regenerated acid 145 and regenerated base 170, respectively.

Regenerated base 170 can be circulated back to capture assembly 110, which in the instance of a scrubbing assembly to the scrubbing column 112 as scrubbing solution 114 to capture additional CO₂. In instances where regenerated base 170 is circulated back to scrubbing column 112 as slurry scrubbing solution 114, regenerated base 170 can comprise a portion of scrubbing solution 114, such as being mixed with a fresh portion of slurry scrubbing solution 114. In some alternative aspects, regenerated base 170 is continually circulated, such that regenerated base 170 becomes regenerated scrubbing solution that is part and parcel of slurry scrubbing solution 114 once introduced into slurry column 112. In some preferred aspects, regenerated slurry scrubbing solution preferably comprising sodium hydroxide, sodium carbonate, or a mixture thereof. In some other preferred aspects, regenerated slurry scrubbing solution comprises sodium hydroxide.

Regenerated acid 145 can be circulated back to regeneration assembly 120 for additional reaction with resultant product 140 to regenerated CO₂ 160 and resultant salt solution 150.

As provided by the foregoing disclosure of CO₂ capture and regeneration system 100, the process of capture and regenerating CO₂ and the associated reagents can be a continuous process. In certain aspects of the present invention. NaHCO₃ formed in the capture assembly 110 can be subjected to acid regeneration in the presence of an acid to regenerate CO₂ in a purified form and form a resultant salt solution, and then the resultant salt solution can be subjected to EDBM to regenerate an alkali absorbent solution. Employing the acid regeneration and EDBM to the resultant salt solution not only regenerates a high level of CO₂, but the separation of a salt solution into acid and base, such that the starting acid and base reagents are also substantially regenerated. Accordingly, the alkali absorbent solutions that can capture CO₂ from the gaseous feedstock, such as a flue gas, can be recycled and reused, preferably recycled and reused in a continuous manner.

In some aspects, the system and process of the present invention includes capturing CO₂ in a scrubbing column with a scrubbing solution, in some aspects an alkali absorbent solution, in some aspects an alkali metal hydroxide solution, in some preferred aspects sodium hydroxide (NaOH), to form a NaHCO₃ solution, and then regenerating pure CO₂ by an acid regeneration process comprising reacting the NaHCO₃ solution with an acid, in some aspects a mineral acid, in some preferred aspects sulfuric acid (H₂SO₄), to form a resultant salt solution, in some preferred aspects a sodium sulfate (Na₂SO₄) solution.

In some aspects, the resultant salt solution, such as the preferred Na₂SO₄ solution, is subjected to electrodialysis with bipolar membrane (EDBM) for regenerating the starting scrubbing solution, such as the preferred alkali absorbent solution, more preferably the NaOH solution. The EDBM also regenerates the acid that reacts with the NaHCO₃ solution. One unique aspect of acid regeneration is the high recovery of CO₂, which then allows employing the EDBM method to essentially separate the salt solution into acid and base, thus achieving low reagent regeneration energy of CO₂ and the scrubbing solution.

In some aspects, the reagent regeneration of the present invention eliminates the disadvantages of direct electrodialysis of NaHCO₃, such as low current efficiency, low CO₂ recovery (40-60%) and high cell resistance.

Also, switching from toxic reagents like amines to alkali absorbents like sodium carbonate and sodium hydroxide can further save reagent costs. Still further, the cost of reagent regeneration energy utilizing EDBM according to certain embodiments of the present invention is anticipated to even go down further as membrane prices decrease in cost. Solar energy, or other renewable energy sources, can be used for energizing EDBM cell, further minimizing energy costs. These traits not only make the technology of the present invention economically feasible, but also environmentally benign.

The chemical reactions for CO₂ capture with alkali absorbent solutions of NaOH and Na₂CO₃ are shown in Equations (1)-(3):

CO₂(aq)+H₂O(l)→H₂CO₃(aq) (1)

H₂CO₃(aq)+Na₂CO₃(aq)→NaHCO₃(aq) (2)

NaOH(aq)+H₂CO₃(aq)↔NaHCO₃(aq)+H₂O(l) (3)

As provided in FIGS. 2 and 3, the resultant NaHCO₃ solution from these chemical-reaction type capture of CO₂ can be reacted with an acid for CO₂ regeneration and producing a resultant salt solution, and then the resultant salt solution can be subjected to EDBM to regenerate the alkali absorbent solution and the acid.

For example, the reaction in Equation (4) has been found to effectively liberate CO₂ from bicarbonate:

H₂SO₄+2NaHCO₃→Na₂SO₄+2H₂O+2CO₂ (4)

As provided in FIGS. 2 and 3, the Na₂SO₄ salt solution from Equation (4) can be separated back into acid (H₂SO₄) and base (NaOH) by employing the EDBM process. The resultant base solution can be recirculated back for the absorption of CO₂. The present inventors have achieved 100% CO₂ recovery from this regeneration method, with significantly less energy consumption than other regeneration processes. The present invention not only is capable of recovering 100% CO₂ and effectively regenerating the acid and base solutions while utilizing less energy consumption than other regeneration processes, but the present invention eliminates all the disadvantages of direct electrodialysis of NaHCO₃, such as low current efficiency, low CO₂ recovery (40-60%) and high cell resistance.

Without wishing to be bound by theory, the EDBM process uses a bi-polar membrane to specifically catalyze water dissociation to form free protons and hydroxide anions as shown in Equation (5):

H₂O→H⁺+OH⁻ (5)

Then, as shown in FIG. 4A, the EDBM comprises a series of cation exchange membranes (CEM) and bipolar membranes (BPM) proximately located between the anode and cathode. The CEMs allow for the diffusion of the Na⁺ cations, and the BPMs allow the OH⁻ and H⁺ ions to migrate between the cathode and anode. Using the series of CEMs and BPMs proximately located between the anode and cathode, Na⁺ is allowed to diffuse into the cathode side of the cell, where it meets the OH anion to form NaOH in the base compartment: while SO²⁻₄ reacts with H⁺ generated from bipolar junction to form H₂SO₄ in the acid compartment. As illustrated in FIG. 3, the base compartment is the space between a CEM and an adjacent BPM proximately located on the cathode side of the CEM, and the acid compartment is the space between a CEM and an adjacent BPM proximately located on the anode side of the CEM. For purposes of clarification, it is noted that in contrast to employing EDBM, conventional electrolysis for water splitting reaction generates H₂ and O₂ gases, which consumes almost half the energy provided to the cell.

It is also noted that the function of an ion exchange membrane is to act like a thin selective barrier. Such membranes enable the electrically-driven selective transfer of ions between the two solutions, which they separate. Ion exchange membranes are composed of a polymer matrix on which are fixed ionized functional groups. These fixed charges are neutralized by mobile ions of opposite charge, called counter ions. Due to the Donnan effect, in an electrolyte solution, such membrane tends to reject ions with the same charge as the ionized groups, called co-ions. The cation exchange membranes (CEM) utilized in the EDBM exchange only cations between cathode and anode compartments, which is in contrast to anion exchange membranes (AEM) that exchange only anions between the electrode compartments in an electrolysis cell.

The bipolar membrane (BPM) utilized in the EDBM is composed of one cation-exchange layer and one anion-exchange layer joined together, which is used for water splitting. In contrast to cationic and anionic membranes, bipolar membranes have a required orientation between the electrodes: the anion-exchange layer should be oriented towards the cathode, and cation-exchange layer should be oriented towards the anode. If BPMs are placed with the wrong orientation, ions accumulate between the two layers resulting in blistering of the membranes. Unlike the conventional electrolysis, gas generation is minimized in the EDBM process due to membranes restricting the H′ and OH ions from reaching the electrode. Hence, theoretically the energy requirement is reduced to about 40% of what is required for water electrolysis. With an increase in number of unit cells or membrane stacks in the EDBM compartment, total energy consumption decreases, due to decrease in energy consumption in electrode compartment with minimized gas generation.

In some aspects, the scrubber solution provides a CO₂ capture efficiency of at least 90%, in some aspects at least 92.5%, in some aspects at least 95%, in some aspects at least 95.5%, in some aspects at least 96%, in some aspects at least 96.5% and in some aspects at least 97%.

In some preferred aspects, the scrubber solution comprises sodium hydroxide having a concentration between about 0.05 mol/L up to about 1 mol/L, preferably between about 0.075 mol/L up to about 0.75 mol/L, more preferably between about 0.1 mol/L up to about 0.5 mol/L, and in some preferred aspects preferably between about 0.25 mol/L up to about 0.4 mol/L.

The scrubber solution preferably captures CO₂ forming a captured CO₂ solution. In some aspects, the captured CO₂ solution comprises a sodium bicarbonate solution. In some preferred aspects, a scrubber solution comprising sodium hydroxide reacts with a flue gas to capture CO₂ forming the captured CO₂ solution comprising a sodium bicarbonate solution. Preferably the captured CO₂ solution is a sodium bicarbonate solution. In some preferred aspects, the captured CO₂ solution comprises at least 80%, in some aspects at least 85%, in some aspects at least 90%, in some aspects at least 95%, in some aspects at least 97.5%, in some aspects at least 98%, in some aspects at least 98.5%, in some aspects at least 99%, in some aspects at least 99.5%, in some aspects at least 99.9%, and in some aspects 100%, of a sodium bicarbonate solution.

In some aspects, the CO₂ is regenerated from the captured CO₂ solution such that a recovery rate of at least 90% is achieved, in some aspects at least 95%, in some aspects at least 98%, in some aspects at least 99%, in some aspects at least 99.5%, in some aspects at least 99.9%, and in some aspects essentially 100%.

In some aspects, the regenerated CO₂ produced from the captured CO₂ solution has a purity of at least 90%, in some aspects at least 95%, in some aspects at least 97.5%, in some aspects at least 98%, in some aspects at least 99%, in some aspects at least 99.5%, in some aspects at least 99.9%, and in some aspects essentially 100%.

The regenerated CO₂ is preferably produced by reacting the captured CO₂ solution with an acid reagent to provide the regenerated CO₂ and a resultant salt solution.

In some aspects, the scrubber solution is regenerated from the resultant salt solution by electrodialysis such that a regenerated scrubber solution yield of at least 90% is achieved, in some aspects at least 95%, in some aspects at least 98%, in some aspects at least 99%, in some aspects at least 99.5%, in some aspects at least 99.9%, and in some aspects essentially 100%.

In some aspects, the acid reagent is regenerated from the resultant salt solution by electrodialysis such that a regenerated acid reagent yield of at least 90% is achieved, in some aspects at least 95%, in some aspects at least 98%, in some aspects at least 99%, in some aspects at least 99.5%, in some aspects at least 99.9%, and in some aspects essentially 100%. In some aspects, the scrubber solution and the acid reagent are both regenerated from the resultant salt solution by electrodialysis, such that a regenerated scrubber solution yield of at least 90% is achieved and a regenerated acid reagent yield of at least 90% is achieved, in some aspects at least 95%, in some aspects at least 98%, in some aspects at least 99%, in some aspects at least 99.5%, in some aspects at least 99.9%, and in some aspects essentially 100%, for both the regenerated scrubber solution yield and the regenerated acid reagent yield.

### EXPERIMENTAL

Continuous CO₂ capture and regeneration experiments were conducted on a mini pilot scale setup, as illustrated in the block diagram of FIG. 3, comprising a scrubber having scrubbing solution and a gaseous mixture inlet, an acid/base reaction tank in fluid communication with the scrubber, and an EDBM cell in fluid communication with the scrubber and also the acid/base reaction tank. As provided in FIG. 3, the NaHCO₃ solution formed by the capture of CO₂ by the scrubbing solution in the scrubber is fed to the acid/base reaction tank. Clean CO₂ is regenerated in the acid/base reaction tank by reacting the NaHCO₃ solution with an acid and also forming a resultant salt solution. The resultant salt solution is fed to the EDBM cell, wherein the acid and base are separated thereby regenerating a scrubbing solution for the scrubber and an acid for the acid/base reaction tank.

### Materials and Methods

CO₂ absorption with NaOH

The scrubber column shown on the left side in FIG. 3 was used as a counter-current packed-bed absorption column. Column dimensions: Height: 275 cm; Diameter: 10.16 cm; Packing: Polypropylene pall rings 1.2 cm×1.2 cm; Packed bed height: 122 cm. To simulate flue gas, a gaseous mixture containing 16% volume CO₂ and the remaining 84% air was continuously fed into an air inlet proximately located the bottom of the scrubbing column with the help of a gas diffuser. Gas flow rate was maintained at 25 LPM. Separate flow meters were installed for CO₂ and air to measure the volumetric flow and to control the percentage of CO₂ in the gas stream. CO₂ and air flow rates were measured with gas flow meters (OMEGA) equipped with gas controllers (McMaster-Carr).

The percentage CO₂ of the simulated flue gas exiting out from the top of the column was measured with Quantek Model 906 infrared gas analyzer calibrated with a 20-vol % CO₂/N₂ reference gas. CO₂ capture efficiency of a NaOH solution as the scrubbing solution was measured by continuously recording percentage CO₂ absorption data by the data logger connected to the gas analyzer. After each experiment the data logger was connected to the computer and the graph generated from it was integrated to calculate the total moles of CO₂ absorbed per minute. The accuracy of the data was ensured by repeating these experiments in triplicates. For a 16% CO₂ gas stream (simulating a power plant flue gas), the optimum parameters were found to be: 0.3 mol/L NaOH solution at 6.4 Liters per minute flow rate.

Scrubber Solution Regeneration with EDBM

The scrubber solution, particularly a NaOH solution, was regenerated through an EDBM unit as shown in FIG. 3. The electrodialysis setup shown in FIGS. 4A-4B consisted of a DC power supply (XHR40-25, AMETEK: 0-40 V, 0-25 A) to maintain constant current field. The electrodialysis cell components and membrane stack were obtained from Ameridia—The Eurodia Group (properties given in Table 1). Membranes were separated by 0.8 mm thick spacers. To maintain the same pressure between acid, salt, and base compartments, pressure gauges (15 psi max) were installed. Volumetric flow was measured with flow meters (OMEGA). The EDBM unit was equipped with instruments to measure conductivity, voltage, current and temperature.

TABLE 1
Properties of membranes used in EDBM stack.

| | | Area | Burst | | |
|---|---|---|---|---|---|
| | Thickness | resistance | strength | Selectivity | Efficiency |
| Membrane | (mm) | (Ω · cm²) | (kPa) | (%) | (%) |
| CBM cation- | 0.21 | 4.5 | ≥400 | >98 | — |
| exchange | | | | | |
| membrane | | | | | |
| Neosepta ® | 0.22 | — | ≥400 | — | >98 |
| bipolar | | | | | |
| membrane | | | | | |

In the setup illustrated in FIG. 3, after CO₂ is absorbed in the scrubber column, the absorbent solution (NaHCO₃) is reacted with H₂SO₄ solution in the acid/base reaction tank, and the resultant Na₂SO₄ solution is fed into the electrodialysis cell. The salt solution (0.2 M Na₂SO₄) was prepared by mixing Na₂SO₄ in water. Na₂SO₄>99% reagent grade was obtained from Sigma-Aldrich. To ensure an initial conductivity greater than 20 mS/cm, acid and base tanks were mixed with H₂SO₄ and NaOH, respectively. NaOH >98% reagent grade was obtained from Sigma-Aldrich. 98% w/w H₂SO₄ was obtained from Fisher Scientific. NaOH concentration from the base compartment was measured by titration with 0.01 mol/L HCl standard solution. Acid concentration was estimated by measuring the pH constantly with Oakton 150 hand held pH meter. The solution in the acid/base reaction tank was continuously stirred with an immersion drum mixer. The experimental conditions used for the setup shown in FIG. 3 are provided in Table 2. For the idling procedure, each compartment was filled with deionized water. If the idle time lasted more than a day, each compartment was filled with salt solution at 30 g/L (50 mS/cm conductivity).

TABLE 2
Operating parameters for the experimental setup shown in FIG. 4.
Experimental Conditions

| | |
|---|---|
| Scrubbing liquid to gas ratio (L/G:Kg/Kg) | 4.3 |
| Gas composition | 16% vol. CO₂, remaining |
| | air |
| Gas inlet temperature (° C.) | 31 |
| EDBM cell volume (m³) | 0.012 |
| EDBM cell voltage (V) | 10-20 |
| Current (A) | 1-16 |
| Temperature (° C.) | 30 |
| Pressure (kPa) | 101.32 |
| Initial conductivity of acid/salt and | 20 |
| base compartment (mS/cm) | |
| Maximum conductivity (mS/cm( | 220 |
| Single membrane area (m²) | 0.04 |

### Experimental Procedure

CO₂ capture and regeneration experiments were conducted with the setup shown in FIG. 3. Before running this setup in continuous mode. CO₂ capture experiments were conducted in the scrubber with different concentrations of NaOH. Concentrations of 0.1-0.4 mol/L were tested and a maximum CO₂ capture efficiency of 97% was observed at concentrations of 0.3 mol/L and higher. After finding that 0.3 mol/L was the optimum concentration for achieving maximum absorption efficiency, the EDBM setup was run for 30 min to achieve desired NaOH concentration.

Before running and regeneration setup in continuous mode with the capture column, EDBM cell was run for 30 minutes until the desired acid and base concentrations were reached, starting with 0.2 mol/L Na₂SO₄, 0.1 mol/L NaOH and 0.02 mol/L H₂SO₄ concentrations. Acid and base concentrations were started at 0.024 mol/L and 0.1 mol/L, respectively, to ensure the initial conductivity of the cell was greater than 20 mS/cm, for proper functioning of EDBM. Several voltage ranges were tested for the EDBM cell, and for each constant voltage, current density was recorded every minute until it reached a maximum value. Then the setup shown in FIG. 3 was run in continuous mode for 3 hours to ensure no discrepancy in CO₂ capture and regeneration. CO₂ absorption data was continuously recorded by the gas analyzer for the entire duration of the experiment. CO₂ absorption was continuous at 97% absorption efficiency throughout the duration of 3 hours. Each experiment was repeated three times to ensure reproducibility.

### Results and Discussion

CO₂ Absorption with NaOH

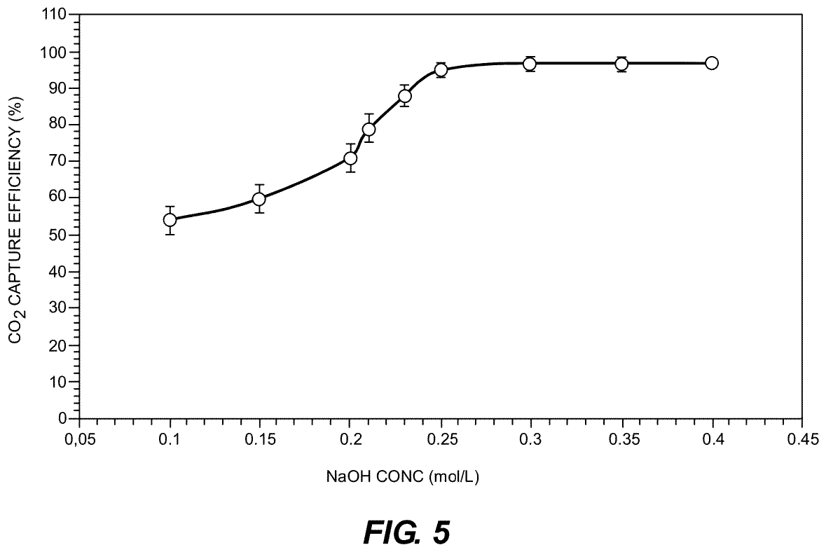

The CO₂ absorption efficiency of NaOH solution at various concentrations is shown in FIG. 5. Initial absorption experiments were conducted with NaOH concentration ranging from 0.1 mol/L to 0.4 mol/L. As shown in FIG. 5, the absorption efficiency of the solution slowly increased with increasing NaOH concentration, finally reaching an asymptote after 0.3 mol/L at 97% capture efficiency.

NaOH Regeneration with EDBM

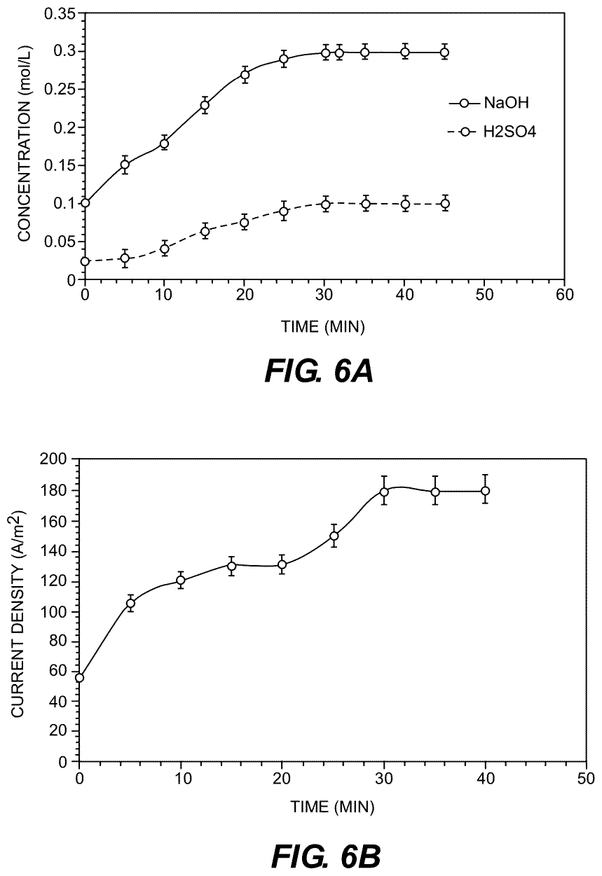

Initial batch tests were conducted on EDBM cell for 30 minutes until the desired acid and base concentrations were reached. The maximum acid and base concentrations were reached in about 30 minutes as shown in FIG. 6A. FIG. 6A shows an increase in acid and base concentration with time, until both the acid and base reach asymptote after about 30 minutes, then the continuous CO₂ capture and regeneration experiments were run for 3 hours with constant current intensity. As shown in FIG. 6B, at constant voltage the current density increased with an increase in time, acid and base concentration due to an increase in conductivity. Once maximum conductivity is reached, the cell operates at a constant current intensity for a given voltage. All the experiments were repeated through three independent measurements. The experimental uncertainty was calculated, and the results were plotted within 95% confidence interval.

Comparing Two Compartment Configuration with Three Compartment Configuration

FIGS. 4A-4B show additional detail of the two compartment EDBM configuration used in the systems of FIGS. 2 and 3 of the present disclosure. The two-compartment configuration has BPM and CEM as the repeating unit cell. The number of repeating unit cells can be greater than 1 and up to 100 or more, and contemplated to be any subset within the foregoing range. In this system, the number of repeating unit cells was 7. In three compartment configurations, the repeating unit cell has AEM, CEM and BPM in respective order. Three compartment configurations are generally used for creating higher concentration of both acid and base. Three compartment configurations tend to create concentrations of more than twice that of two compartment cells. In the present experiment, dilute concentrations of acid and base are required, such that a two-compartment configuration is advantageous in achieving high current efficiency at low voltage ranges. It has also been previously observed that a two compartment EDBM configuration reaches desired maximum acid and base concentrations in less time (within first 60 min) compared to three compartment configurations (few hours). In the present experiment, the maximum acid and base concentrations were reached in about 30 minutes as shown in FIG. 6A. Although, this time is only significant during the batch testing, in continuous mode two compartment configuration consumes less energy due to lower acid and base concentrations required for the present system.

### Effect of Current Density on Energy Consumption, Current Efficiency and NaOH Concentration

Since the energy consumption was the primary focus, the effect of current density on energy consumption was studied. Current density and energy consumption also have a direct influence on NaOH concentration, which in turn has an effect on CO₂ capture efficiency. With increase in the concentration of electrolyte solution (0.2 M Na₂SO₄), the current efficiency decreases. Also, higher concentration leads to high osmotic pressures and reduction in water dissociation at the bipolar membrane.

### Current Efficiency

Current efficiency defines how effectively the ions are transported across the membranes. Current efficiency decreases as the electrolyte and base concentrations increase. A low current efficiency may also result from the imperfect orientation of the membranes that allow the transfer of some co-ions, particularly when the concentrations are higher. Current efficiency is calculated from Equation (6).

$$η = \frac{z \cdot F \cdot V ( {C}_{t} - {C}_{0} )}{n \cdot I \cdot t} \qquad ( 6 )$$

where n is the number of cells (repeating membrane units; n=7 in the present experiment), V (L) is the circulated volume of the solution. F is Faraday's constant (96,500 coulombs/mol) Co and C; are the concentrations (mol/L) of NaOH at time 0 and time t, z=1 in the present situation with OH carrying unit negative charge, and I(A) is the current across the cell.

### Energy Consumption

Total energy consumption in kWh Kg⁻¹ of CO₂ captured is calculated from Equation (7). This energy is converted to MJ Kg⁻¹ by multiplying with a conversion factor of 3.6.

$$Energy consumption = \int \frac{U \cdot I \cdot dt}{{V}_{t} \cdot {C}_{t} \cdot M} \qquad ( 7 )$$

wherein U (V) is voltage across EDBM cell, I(A) is the current across the cell, C; is the concentration of CO₂ at time t. Vt (L) is the volume of the solution circulating through the setup, and M is the molecular weight of CO₂ (44.01 g/mol).

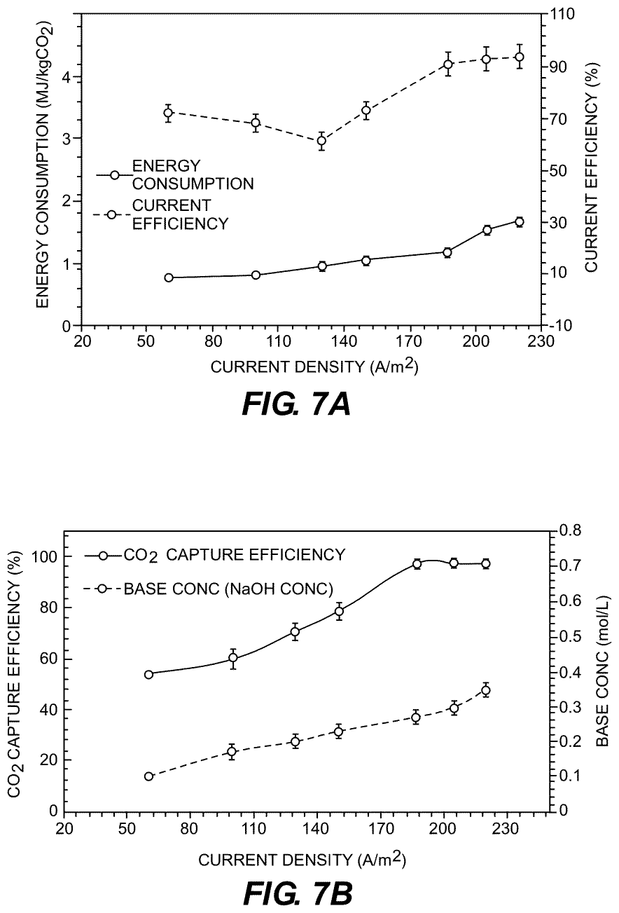

FIG. 7A shows the effect of current density on energy consumption and current efficiency. Current efficiency initially decreases with increase in current density because of low ion selectivity of membranes at lower ranges of current density, but current efficiency starts to increase once the current density is over 140 A/m² due to higher ion transport in the base compartment because of higher conductivity. Increase in current density from 150 A/m² to 180 A/m² only increases the energy slightly from 1.03 to 1.18 MJ, but this increase is more pronounced from 190 A/m² to 200 A/m² due to increase in base concentration at peak current (I) from Equation (7). Increasing the base concentration by more than 0). 3 mol/L increased the current efficiency, but it also increased the overall energy consumption. Considering the total energy consumption as the criteria for the overall process, it would be desirable to stay below the current density of 180 A/m².

Decrease in current efficiency was observed at lower current density and base concentrations. In the two-compartment configuration the hydron (H′), which migrates through the cation exchange membrane and recombines with hydroxide ion (OH), slightly reducing the current utilization. The energy consumption is less in case of two compartment configurations because of dilute base concentration, while that of acid concentration effect on energy consumption follows the opposite trend, as previously observed by others when conducting studies on recovery of H₂SO₄ from Na₂SO₄ salt solution.

FIG. 7B indicates that as the current density increases, the base concentration keeps increasing, but the CO₂ capture efficiency reaches a plateau at 97% capture efficiency. Increasing the base concentration further will leave unreacted NaOH in the captured solution. Further increasing the base concentration will increase the energy consumption of EDBM cell at higher current densities as shown in FIG. 7A. So, the optimum values for the current density and base concentration are: 181.7 A/m² and 0.3 mol/L respectively, keeping the energy consumption minimum and achieving 97% CO₂ capture efficiency. Therefore, the optimum operating conditions of the cell are: 18 V. 7.5 A.

### Performance Evaluation

The regeneration energy of 1.18 MJ/KgCO₂ when compared to 3-4 MJ/KgCO₂ in case of thermal regeneration with amines and other absorbent solutions is a huge breakthrough in terms of energy savings. In the case of thermal regeneration, evidence suggests that an increase in stripper energy from 3 MJ/KgCO₂ to 4 MJ/KgCO₂ will reduce the power plant output by at least 20%. The important advantage of using EDBM process is that renewable sources like photovoltaics can be used to energize the EDBM cell. Some researchers who worked on direct electrodialysis of NaHCO₃ solution were able to achieve low energy values (2-3 MJ/KgCO₂) compared to thermal regeneration, but the direct electrodialysis process has its own fair share of process complications as mentioned above, and more importantly very low CO₂ recoveries (40-60%).

As opposed to direct electrodialysis, an important trait in the presently disclosed process is the greater than 60%, in some aspects greater than 70%, in some aspects greater than 80%, in some aspects greater than 90%, in some preferable aspects greater than 95%, in some other preferable aspects greater than 98%, in some even more preferable aspects greater than 99%, in some aspects up to 99.5%, in some aspects up to 99.6%, in some aspects up to 99.7%, in some aspects up to 99.8%, in some aspects up to 99.9%, in some aspects up to 99.99%, and in the most preferable aspect up to 100%, recovery rate of CO₂.

Since all the CO₂ is essentially capable of being recovered prior to the EDBM step, the system and method of the present disclosure eliminates the presence of gas bubbles in the cell, avoiding unnecessary resistance across the cell. Hence, a very high current efficiency of 91% was observed, due to relatively lower concentration of acid and base generated. It is hypothesized that the limitation in current efficiency could be due to the leakage of protons through the cation exchange membrane. In a commercial scale EDBM unit, the number of unit cells could be much larger as opposed to lab scale unit of the present experiment, in which case voltage drop across the EDBM stack would be much less at lower current densities. Thus, the energy requirement is anticipated to be further lowered in a commercial scale unit.

An advantage of the system and regeneration method of the present disclosure is that the regeneration can be performed at room temperature and atmospheric pressure conditions, as opposed to high pressures required for direct electrodialysis of NaHCO₃ as mentioned earlier. This ensures high process safety and also easier start-up and shutdown.

In some aspects, a particulate filtration step is recommended before the scrubber to ensure no particulates enter the EDBM cell. The usual norm in industrial flue gas capture is to remove/filter suspended particulates before sending the gas for flue gas desulfurization (FGD) and subsequently CO₂ capture. Accordingly, the system and method of the present disclosure may in some aspects having a particulate filter and particulate filtration step prior to the scrubber in order to avoid suspended solids going into the EDBM cell and fouling membranes.

### Cost Estimation

Economic analysis was also carried out by considering a hypothetical case of 400 MW coal-fired power plant, which corresponds to 300 tons/h of CO₂ emissions and a continuous operation of CO₂ capture and regeneration for 350 days a year at 24 h per day. With 97% CO₂ capture efficiency of NaOH from the foregoing experimental results, this accounts to 2.4 Mton/year of CO₂ captured. All assumptions for cost estimation are shown in Table 3.

TABLE 3
Operating parameters and assumptions made for cost
estimation of CO₂ capture with EDBM regeneration.

| Parameter | | Life Span |
|---|---|---|
| Number of EDBM cells | 2867 | 15 years |
| Bi-polar membrane price ($/cm²) | 0.43 | 5 years |
| Cation exchange membrane price ($/cm²) | 0.24 | 5 years |
| Electricity cost ($/kWh) | 0.06 | — |
| Cost of each EDBM stack ($/cm²) | 1.005 | — |

Considering the foregoing base case scenario for capital cost, the operating cost is estimated by calculating the direct energy cost.

### Cost of CO₂ Absorption

Cost of CO₂ capture with thermal regeneration from previous literature was estimated to be around 45-60$/ton of CO₂ captured, and others estimated that 30% of this cost corresponds to CO₂ absorption equipment, which includes absorption column and pumping system. Considering the same base case scenario, the CO₂ absorption cost is estimated to be 13.5$/ton of CO₂ captured.

### Cost of CO₂ Regeneration

Cost of CO₂ regeneration or reagent regeneration was estimated based on laboratory results of EDBM experiments. The cell in the lab has a cell volume of 0.012 m³ and handles 7.5 L/min of solution. At the L/G ratio of 4.3 and gas flow of 5 tons/min the total liquid to be handled by EDBM cells is 21500 LPM. Therefore, the number of cells required are 2867. Cost of each EDBM stack was estimated as 1.5 times the cost of membranes, based on previous work in the industry. Total equipment cost and operating costs are provided in Table 4.

TABLE 4
Total equipment costs (TEC) and operating costs.

| Capital costs | (Million $) |
|---|---|
| Cost of EDBM cells (including membrane cost) | 26.62 |
| Other equipment* | 28.5 |
| TEC | 55.12 |
| | ($/ton of CO₂ |
| Operating costs | captured) |
| Energy cost | 19.62 |
| Labor and maintenance (13% of Investment Cost) | 0.52 |
| Other variable costs** | 0.39 |

*Other equipment includes spacers, pipelines, pumps, CO₂ compression etc., as estimated by the work of Sabatino et al. (2020).
**Other variable costs include pumping costs and other miscellaneous expenses.

Total capital cost including equipment cost, construction, valves, piping, etc. is calculated based on NETL guidelines as provide in Table 5.

TABLE 5
Total capital cost considerations.

| | |
|---|---|
| Total installation cost (TIC) | 80% TEC |
| Total direct plant cost (TDPC) | TEC + TIC |
| Indirect costs (IC) | 13% TDPC |
| Engineering, procurement and construction (EPC) | TDPC + IC |
| Total contingencies and owner's cost (C&OC) | 30% EPC |
| Total capital (TC) | EPC + C&OC |

The total capital investment is about 145.73 M$ for 15 years of operation and 36 Mtons of total CO₂ processed. As such, for 1 ton of CO₂, captured the total capital investment turns out to be about 4.04$/ton of CO₂ captured. If both capital expenditure and variable operating costs are combined, the total cost of CO₂ capture and regeneration would be 38.07$/ton of CO₂ captured. Although the operating costs are very low, the capital cost increases the total cost due to high EDBM unit prices and membrane prices. Membrane prices are expected to go down further in the future, in such a case the total cost can be less than 38.07$/ton of CO₂.

Depending on the project timeline, EDBM will be advantageous if the project period is extended over 15 years. It can also be made profitable over a shorter period of time if the membrane prices are lowered. Further decreases in electricity costs may also be anticipated by 2050, with developments in renewable energy technologies.

An additional benefit of the EDBM method is that you can regulate the base concentration as required by adjusting the voltage and current across the cell. If the CO₂ concentration from the flue gas is fluctuating due to load variation from the power plant, this turning might help reduce the cost on daily basis. Considering 15 years of project timeline, the average cost per ton of CO₂ captured is roughly 38$. It is contemplated that the reagent regeneration energy of 1.18 MJ/kg could be further reduced with numerous performance improvements and careful design choices, further making CO₂ capture economically feasible and environmentally benign.

As provided by the foregoing, the present inventors have developed a new regeneration method for CO₂ capture with an alkali absorbent solution, whereby sodium bicarbonate is reacted with an acid, preferably sulfuric acid, and the resultant salt solution, preferably a sodium sulphate solution, is subjected to an EDBM process for regenerating the alkali absorbent solution, preferably NaOH, and the acid. The present inventor were able to achieve reagent regeneration energy as low as 1.18 MJ/kg of CO₂ captured at a current efficiency of 91.2% for the EDBM cell. The cost of processing flue gas is around 38.07$/ton of CO₂ captured based on 2020 prices. This cost could be even lower if membrane costs were competitive. As such, the system and process of the present invention provides a very promising choice for post-combustion CO₂ capture.

1. A system of capturing carbon dioxide from a gaseous feedstock that is configured for regenerating carbon dioxide and one or more reagents utilized in capturing carbon dioxide from the gaseous feedstock, the system comprising:
a scrubber unit in fluid communication with the gaseous feedstock and a scrubber solution, wherein a reaction between the scrubber solution and carbon dioxide occurs in the scrubber unit to form a captured carbon dioxide solution that exits the scrubber unit;
a reaction tank in fluid communication with the scrubber column, wherein the reaction tank is configured to receive the captured carbon dioxide solution from the scrubber unit and react the captured carbon dioxide solution with an acid reagent to form a cleaned carbon dioxide and a resultant salt solution, wherein the cleaned carbon dioxide has a purity that is greater than that of the gaseous feedstock, and wherein the resultant salt solution exits the reaction tank; and
an electrodialysis regeneration unit in fluid communication with the reaction tank, wherein the electrodialysis regeneration unit comprises a bipolar separation membrane, and wherein the electrodialysis regeneration unit is configured to receive the resultant salt solution that is subjected to electrodialysis with bipolar membrane separation for separation of the resultant salt solution into an acid and a base;
wherein the acid from the electrodialysis regeneration unit comprises a regenerated acid reagent; and
wherein the base from the electrodialysis regeneration unit comprises a regenerated scrubber solution.

2. A method of capturing carbon dioxide from a gaseous feedstock and regenerating carbon dioxide and one or more reagents utilized in capturing carbon dioxide from the gaseous feedstock, the method comprising:
reacting a scrubber solution with carbon dioxide in the gaseous feedstock in a scrubber unit to form a captured carbon dioxide solution;
regenerating carbon dioxide from the captured carbon dioxide solution by reacting the captured carbon dioxide solution with an acid reagent in a reaction tank to form a cleaned carbon dioxide and a resultant salt solution, wherein the cleaned carbon dioxide has a purity that is greater than that of the gaseous feedstock; and
subjecting the resultant salt solution to electrodialysis with bipolar membrane separation in an electrodialysis regeneration unit to separate the resultant salt solution into an acid and a base;
wherein the acid from electrodialysis comprises a regenerated acid reagent; and
wherein the base from electrodialysis comprises a regenerated scrubber solution.

3. The system of claim 1, wherein the gaseous feedstock is a flue gas.

4. The system of claim 1, wherein the scrubber unit comprises a scrubber column, wherein the scrubber solution flows in an opposite direction than the gaseous feedstock.

5. The system of claim 1, wherein the scrubber solution comprises an alkali metal hydroxide, such that the scrubber solution captures carbon dioxide from the gaseous feedstock by forming the captured carbon dioxide solution comprising an alkali metal bicarbonate solution.

6. The system of claim 1, wherein the cleaned carbon dioxide is regenerated from the alkali bicarbonate solution by reaction with the acid reagent to form the clean carbon dioxide and the resultant salt solution.

7. The system of claim 1, wherein the acid reagent comprises sulfuric acid.

8. The system of claim 7, wherein the resultant salt solution comprises an alkali metal sulfate.

9. The system of claim 8, wherein the base comprises sodium sulfate, such that the regenerated acid reagent comprises sulfuric acid and the regenerated base reagent comprises an alkali metal hydroxide.

10. The system of claim 9, wherein the regenerated base is configured to be circulated back to the scrubber unit as the scrubbing solution to capture additional carbon dioxide from the gaseous feedstock.

11. The system of claim 9, wherein the regenerated acid is configured to be circulated back to the acid reaction tank for additional acid reaction with the captured carbon dioxide solution comprising alkali metal bicarbonate for carbon dioxide regeneration.

12. The system of claim 1, wherein carbon dioxide is continuously captured from the gaseous feedstock by the regenerated scrubber solution.

13. The system of claim 1, wherein the regenerated acid reagent and the regenerated scrubbing solution are continuously separated from the resultant salt solution by subjecting the resultant salt solution to electrodialysis with bipolar membrane separation in the electrodialysis regeneration unit.

14. The system of claim 1, wherein carbon dioxide is continually captured from the gaseous feedstock by the scrubbing solution, the cleaned carbon dioxide is continually formed from the captured carbon dioxide solution by reaction with the acid reagent, and the resultant salt solution is continually subjected to electrodialysis with bipolar membrane separation in the electrodialysis regeneration unit to separate the resultant salt solution into the regenerated acid reagent and the regenerated scrubber solution.

15. (canceled)

16. The system of claim 1, wherein the scrubbing solution is an alkali metal hydroxide solution.

17-22. (canceled)

23. The system of claim 1, wherein the scrubbing solution comprises sodium hydroxide, the acid reagent for regenerating the clean carbon dioxide comprises sulfuric acid, and the resultant salt solution comprises a sodium sulfate (Na₂SO₄) solution, such that the regenerated acid reagent comprises sulfuric acid and the regenerated base comprises sodium hydroxide.

24-26. (canceled)

27. Any of the foregoing claims, wherein the electrodialysis regeneration unit having a bipolar separation membrane comprises one or more EDBM cells.

28-30. (canceled)

31. The system of claim 27, wherein each EDBM cell includes at least one cation exchange membrane and at least one bipolar membrane, each of the cation exchange and bipolar membranes proximately located between an anode and a cathode.

32. (canceled)

33. The system of claim 27, wherein each EDBM cell includes a series of membrane assemblies, each membrane assembly having at least one cation exchange membrane and at least two bipolar membranes, wherein each cation exchange membrane proximately located between two adjacent bipolar membranes, such that the membranes are proximately located between an anode and a cathode.

34. The system of claim 27, wherein each EDBM cell has at least one acid compartment and at least one base compartment, the acid compartment defined by the space between the cation exchange membrane and one of the adjacent bipolar membranes proximately located on the anode side of the cation exchange membrane, and the base compartment defined by the space between a cation exchange membrane and one of the adjacent bipolar membranes proximately located on the cathode side of the cation exchange membrane.

35-55. (canceled)
